(19) United States
(12) Patent Application Publication
(10) Pub. No.: US 2026/0073666 A1
(43) Pub. Date: Mar. 12, 2026

(54) MULTI-RESOLUTION MULTI-TEACHER BASED TRAINING OF A COMPUTER VISION MODEL

(71) Applicant: NVIDIA Corporation, Santa Clara, CA (US)

(72) Inventors: Michael Ranzinger, Park City, UT (US); Greg Heinrich, AIX EN PROVENCE (FR); Pavlo Molchanov, Mountain View, CA (US)

(21) Appl. No.: 19/172,500

(22) Filed: Apr. 7, 2025

Related U.S. Application Data
(60) Provisional application No. 63/692,504, filed on Sep. 9, 2024.

(51) Int. Cl. G06V 10/77; G06V 10/52; G06V 10/776; G06V 10/778; G06V 10/82; G06V 10/96

(52) U.S. Cl. CPC G06V 10/7715; G06V 10/52; G06V 10/776; G06V 10/7784; G06V 10/82; G06V 10/96

(57) ABSTRACT

The rise of specialized vision foundation models has created a need for methods to consolidate knowledge from multiple models (i.e. the teachers) into a single model (i.e. the student). However, this type of knowledge agglomeration leaves open several critical challenges, including that teacher models typically operate at varying resolutions due to different architectures and training goals, creating feature granularity inconsistencies, that existing models have different distribution moments which can result in biased learning, and that computer vision models are oftentimes trained to produce features at a particular resolution, and therefore do not generalize well to different tasks requiring different resolutions. The present disclosure provides multi-resolution and multi-teacher based training of a computer vision model, which can capture both fine details and broader abstractions from the teacher models, which can prevent biased learning among the teacher models, and which can produce a flexible computer vision model for different feature resolutions.

### CLAIM OF PRIORITY

This application claims the benefit of U.S. Provisional Application No. 63/692,504 (Attorney Docket No. NVIDP1413+/24-SC-0840US01) titled “BALANCING HETEROGENEOUS MULTI-TEACHER DISTILLATION WITHOUT LABELS,” filed Sep. 9, 2024, the entire contents of which is incorporated herein by reference.

### TECHNICAL FIELD

The present disclosure relates to computer vision models.

### BACKGROUND

The rise of specialized vision foundation models has created a need for methods to consolidate knowledge from multiple models (i.e. the teachers) into a single model (i.e. the student). However, the growing body of work on this type of knowledge agglomeration leaves open several critical challenges.

First, teacher models typically operate at varying resolutions due to different architectures and training goals, creating feature granularity inconsistencies. Second, existing models have different distribution moments which can result in biased learning. Third, computer vision models are oftentimes trained to produce features at a particular resolution, and therefore do not generalize well to different tasks requiring different resolutions.

There is a need for addressing these issues and/or other issues associated with the prior art. For example, there is a need to provide multi-resolution and multi-teacher based training of a computer vision model, which can balance the varying resolutions of the different teachers in the computer vision model to capture both fine details and broader abstractions, which can provide a distillation process that accounts for the different teacher distributions to prevent biased learning, and which can result in a computer vision model that supports various applications requiring different feature resolutions.

### SUMMARY

In an embodiment, a method, computer readable medium, and system are disclosed for training a student computer vision model from a plurality of teacher computer vision models. A plurality of resolutions over which the student computer vision model is to be trained is selected. For each resolution of the plurality of resolutions, the student computer vision model is trained from every teacher computer vision model of the plurality of teacher computer vision models.

In another embodiment, a method, computer readable medium, and system are disclosed for training a student computer vision model from a plurality of normalized teacher computer vision models. A plurality of teacher models are normalized to form a plurality of normalized teacher models. A student model is trained from the plurality of normalized teacher models. The trained student model is configured to reverse the normalization at inference time.

### BRIEF DESCRIPTION OF THE DRAWINGS

FIG. 1A illustrates a flowchart of a method for training a student computer vision model from a plurality of teacher computer vision models, in accordance with an embodiment.

FIG. 1B illustrates a flowchart of a method for training a student model from a plurality of normalized teacher models, in accordance with an embodiment.

FIG. 2 illustrates a system framework for providing multi-resolution multi-teacher based training of a student computer vision model, in accordance with an embodiment.

FIG. 3A illustrates an exemplary mosaic of images used in the system framework of FIG. 2, in accordance with an embodiment.

FIG. 3B illustrates an exemplary padded mosaic of images used in the system framework of FIG. 2, in accordance with an embodiment.

FIG. 4 illustrates a flowchart of a method for executing a trained student model to generate an output, in accordance with an embodiment.

FIG. 5 illustrates a method for token compression, in accordance with an embodiment.

FIG. 6A illustrates inference and/or training logic, according to at least one embodiment.

FIG. 6B illustrates inference and/or training logic, according to at least one embodiment.

FIG. 7 illustrates training and deployment of a neural network, according to at least one embodiment.

FIG. 8 illustrates an example data center system, according to at least one embodiment.

### DETAILED DESCRIPTION

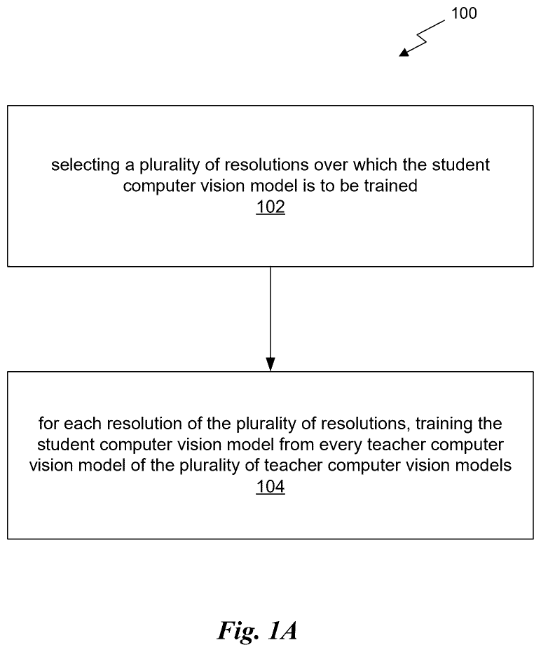

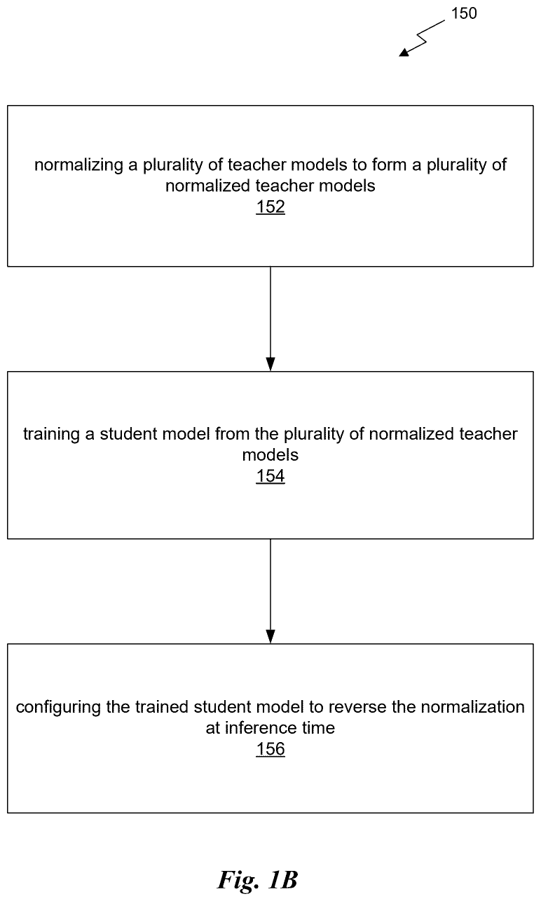

FIG. 1A illustrates a flowchart of a method 100 for training a student computer vision model from a plurality of teacher computer vision models, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

As mentioned above, the method 100 is performed for training a student computer vision model from a plurality of teacher computer vision models. The student computer vision model refers to a (e.g. machine learning) model that learns from the plurality of teacher computer vision models to perform at least one computer vision task. The plurality of teacher computer vision models refer to (e.g. machine learning) models that are pretrained for at least one computer vision task. In an embodiment, the plurality of teacher computer vision models may be pretrained for a plurality of different computer vision tasks.

A computer vision task refers to a task involving an image or a video. For example, the computer vision task may be object detection, which may include identifying and locating an object within an image or video. As another example, the computer vision task may be instance segmentation, which may include identifying individual objects within an image or video frame by providing precise pixel-level boundaries and unique labels for each object instance. As yet another example, the computer vision task may be semantic segmentation, which may include assigning a class label to each pixel in an image or video frame to provide a representation of objects and their boundaries within the image.

As described in more detail below, at least one of the teacher computer vision models may be a flexible teacher computer vision model that is configured to process inputs (e.g. images, videos, etc.) with a plurality of different resolutions. For example, the flexible teacher computer vision model may be pretrained to process inputs at the plurality of different resolutions. In another embodiment, at least one of the teacher computer vision models may be a non-flexible teacher computer vision model that is configured to process inputs (e.g. images, videos, etc.) with only a single predefined resolution. For example, the non-flexible teacher computer vision model may be pretrained to only process inputs at the single resolution. In this context, the student computer vision model may be trained, as described herein, for two or more of different resolutions, and in some embodiments these resolutions may each be supported by at least one of the teacher computer vision models.

Returning to the method 100, in operation 102, a plurality of resolutions over which the student computer vision model is to be trained is selected. In the context of the present embodiment, a resolution refers to the resolution (e.g. dimensions) of an input (e.g. image or video). Just by way of example, a resolution may be 256×256, 432×432, 1024×1024, etc. The plurality of resolutions may include two different resolutions, in an embodiment. In an embodiment, the plurality of resolutions may include more than two different resolutions.

In an embodiment, the plurality of resolutions may be selected from the resolutions supported by the teacher computer vision models. In an embodiment, the selection may be predefined. In an embodiment, the selection may be made by a user.

In operation 104, for each resolution of the plurality of resolutions, the student computer vision model is trained from every teacher computer vision model of the plurality of teacher computer vision models. In an embodiment, the student computer vision model may be trained over the plurality of resolutions sequentially. For example, the student computer vision model may be trained from every teacher computer vision model at a first resolution, then may be trained from every teacher computer vision model at a second resolution, etc. In an embodiment, for each resolution of the plurality of resolutions, the student computer vision model may be trained over a predefined number of iterations. The number of iterations may be the same or different for the various resolutions.

In an embodiment, the student computer vision model may be trained from a flexible teacher computer vision model by: causing the flexible teacher computer vision model to process an input with the resolution to generate a first output with the resolution, causing the student computer vision model to process the input with the resolution to generate a second output with the resolution, computing a loss between the first output and the second output, and updating the student computer vision model based on the loss. The output of a model generated from a given input, as described herein, may refer to a feature map or any other feature representation of the given input. A loss, as mentioned herein, may be computed using a predefined loss function. The loss may refer to a difference between the first output and the second output. Updating the student computer vision model based on the loss may include updating the student computer vision model to minimize the loss. In this embodiment, the input may be of a resolution that is supported by the flexible teacher computer vision model. Thus, the teacher computer vision model may be considered “flexible” for a particular training stage when it supports the resolution at which the student computer vision model is being trained during that particular training stage.

In another embodiment, the student computer vision model may be trained from non-flexible teacher computer vision model by: determining whether the single predefined resolution at which the non-flexible teacher computer vision model is configured to process inputs matches the resolution at which the student computer vision model is being trained, and performing a training process that is dependent on a result of the determination. In an embodiment, when the single predefined resolution at which the non-flexible teacher computer vision model is configured to process inputs matches the resolution at which the student computer vision model is being trained, then the training process may include: causing the non-flexible teacher computer vision model to process an input with the resolution to generate a first output with the resolution, causing the student computer vision model to process the input with the resolution to generate a second output with the resolution, computing a loss between the first output and the second output, and updating the student computer vision model based on the loss.

On the other hand, in an embodiment when the single predefined resolution at which the non-flexible teacher computer vision model is configured to process inputs is lower than the resolution at which the student computer vision model is being trained, then the training process may include: causing the non-flexible teacher computer vision model to process an input with the single predefined resolution at which the non-flexible teacher computer vision model is configured to process inputs to generate a first output with the single predefined resolution, causing the student computer vision model to process the input with the resolution at which the student computer vision model is being trained to generate a second output with the resolution at which the student computer vision model is being trained, downsampling the second output to form a downsampled second output with a resolution that matches the single predefined resolution of the first output, computing a loss between the first output and the downsampled second output, and updating the student computer vision model based on the loss. In an additional embodiment, when the single predefined resolution at which the non-flexible teacher computer vision model is configured to process inputs is lower than the resolution at which the student computer vision model is being trained, then the lower-resolution teacher features may be upsampled to the resolution of the higher-resolution student features. For example, in this additional embodiment, the training process may include: causing the non-flexible teacher computer vision model to process an input with the single predefined resolution at which the non-flexible teacher computer vision model is configured to process inputs to generate a first output with the single predefined resolution, upsampling the first output to form an upsampled second output with a resolution that matches the resolution at which the student computer vision model is being trained, causing the student computer vision model to process the input with the resolution at which the student computer vision model is being trained to generate a third output with the resolution at which the student computer vision model is being trained, computing a loss between the upsampled second output and the third output, and updating the student computer vision model based on the loss.

In a further embodiment, when the single predefined resolution at which the non-flexible teacher computer vision model is configured to process inputs is higher than the resolution at which the student computer vision model is being trained, then the training process may include: aggregating a plurality of inputs having the resolution at which the student computer vision model is being trained to form an aggregate input with the single predefined resolution at which the non-flexible teacher computer vision model is configured to process inputs, causing the non-flexible teacher computer vision model to process the aggregate input with the single predefined resolution at which the non-flexible teacher computer vision model is configured to process inputs to generate a first output with the single predefined resolution, apportioning the first output into a plurality of second outputs that each correspond to a different one of the plurality of inputs and that each have the resolution at which the student computer vision model is being trained, causing the student computer vision model to process the plurality of inputs having the resolution at which the student computer vision model is being trained to generate a plurality of third outputs with the resolution at which the student computer vision model is being trained, and for each input of the plurality of inputs: computing a loss between the second output of the plurality of second outputs that corresponds to the input and the third output of the plurality of third outputs that corresponds to the input, and updating the student computer vision model based on the loss. In an embodiment, the plurality of inputs may be aggregated with a plurality of additional default blocks (e.g. as “padding”) to form the aggregate input with the single predefined resolution at which the non-flexible teacher computer vision model is configured to process inputs. Thus, in an embodiment, the aggregate input at the higher resolution may be considered a “mosaic” of smaller (i.e. resolution-wise) images, which in a further embodiment may include additional padding situated between the smaller images and/or situated at one or more edges of the smaller images.

In an embodiment, the plurality of teacher computer vision models may be normalized for use in training the student computer vision model. In this embodiment, the student computer vision model may be configured to reverse the normalization at inference time. For example, the plurality of teacher computer vision models may be normalized by rotating teacher activations to distribute variance across channels and then may be scaled to obtain unit variance. Further to this example, the normalization may be reversed by projecting student activations back into an original feature space of each of the plurality of teacher computer vision models.

In an embodiment, the student computer vision model may be configured to generate feature tokens for a given input, at inference time. In an embodiment, the student computer vision model may be further configured to compress the feature tokens, at inference time. In an embodiment, the student computer vision model may be configured to compress the feature tokens by merging subsets of the feature tokens at least in part by degree of similarity.

In an embodiment, the method 100 may further include causing the student computer vision model to be deployed for performing inferencing for one or more computer vision tasks. In an embodiment, the student computer vision model may be deployed for use by a downstream application. In an embodiment, the student computer vision model may be deployed for use by a downstream large language model (LLM). In an embodiment, the student computer vision model may be deployed for use by a downstream vector database.

FIG. 1B illustrates a flowchart of a method 150 for training a student model from a plurality of normalized teacher models, in accordance with an embodiment. The method 150 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 150. In another embodiment, a non-transitory computer-readable media may store computer instructions which when executed by one or more processors of a device cause the device to perform the method 150.

The method 150 may be performed to train the student computer vision model in the context of the method 100 of FIG. 1A, in an embodiment. In another embodiment, the method 150 may be performed to train the student computer vision model without also performing the method 100 of FIG. 1A. In either case, the definitions and embodiments described above may apply to the present description.

As shown, in operation 152, a plurality of teacher models are normalized to form a plurality of normalized teacher models. In an embodiment, the plurality of teacher models may be pretrained computer vision models. In an embodiment, the plurality of teacher models may be pretrained for at least one computer vision task. In an embodiment, the plurality of teacher models may be pretrained for a plurality of different computer vision tasks, such as at least one of object detection, instance segmentation, or semantic segmentation.

Normalizing the plurality of teacher models refers to applying some preconfigured preprocessing to the plurality of teacher models. In an embodiment, normalizing the plurality of teacher models may include normalizing distributions of the plurality of teacher models. For example, normalizing the distributions of the plurality of teacher models may include aligning the distributions across the plurality of teacher models.

In another embodiment, the plurality of teacher models may be normalized using an invertible linear mapping. In an embodiment, the plurality of teacher models may be normalized by rotating teacher activations to distribute variance across channels and then scaling to obtain unit variance. As mentioned, the result of the normalizing is a plurality of normalized teacher models.

In operation 154, a student model is trained from the plurality of normalized teacher models. In an embodiment where the plurality of teacher models are pretrained computer vision models, then the student model may be a computer vision model. For example, the student model may be configured to perform any of the computer vision tasks of the plurality of normalized teacher models.

In an embodiment, the student model may be trained in accordance with the method 100 of FIG. 1A. For example, the student model may be trained for each of a plurality of resolutions from every one of the normalized teacher models. In an embodiment, the student model may learn to match the normalized distributions of the plurality of teacher models.

In operation 156, the trained student model is configured to reverse the normalization at inference time. In an embodiment, the trained student model may reverse the normalization at inference time by estimating the distributions of the teacher models using an inverse normalization process on predictions of the trained student model. In an embodiment, the trained student model may reverse the normalization by applying an inverse operation on predictions made by the trained student model. In an embodiment where the plurality of teacher models are normalized by rotating teacher activations to distribute variance across channels and then scaling to obtain unit variance, then the normalization may be reversed by projecting student activations back into an original feature space of each of the plurality of teacher models.

In an embodiment, the method 150 may further include causing the trained student model to be deployed. In an embodiment, the deployed student model may be used by a downstream application for processing a given input to generate an output. For example, where the student model is a computer vision model, the downstream application may input an image or video to the student model to receive as the output features of the input.

Further embodiments will now be provided in the description of the subsequent figures. It should be noted that the embodiments disclosed herein with reference to the method 100 of FIG. 1A and/or the method 150 of FIG. 1B may apply to and/or be used in combination with any of the embodiments of the remaining figures below.

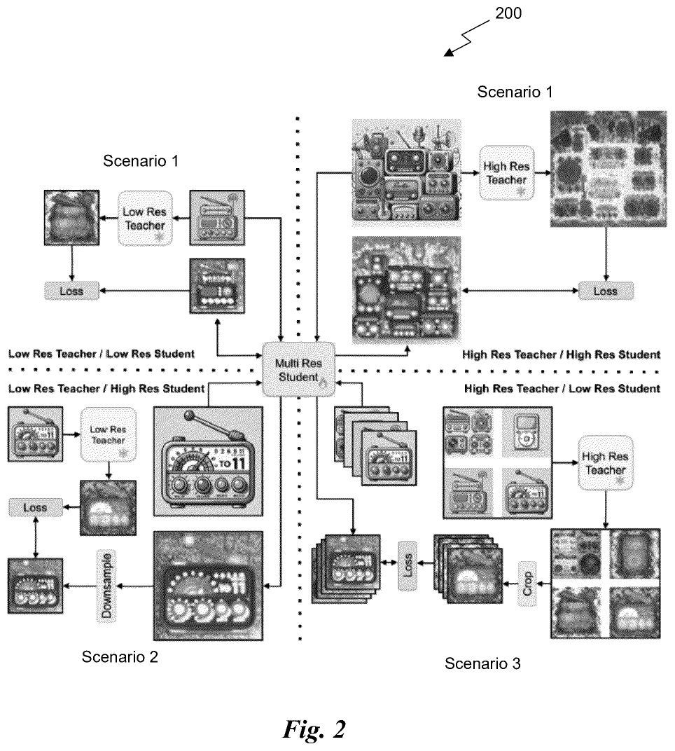

FIG. 2 illustrates a system framework 200 for providing multi-resolution multi-teacher based training of a student computer vision model, in accordance with an embodiment. The system framework 200 may be implemented to carry out the method 100 of FIG. 1A, in an embodiment. The system framework 200 may be implemented in hardware and/or software.

In the present system framework 200, the student model learns from all teacher models at all (selected) resolutions. As a result, the student model is a multi-resolution model capable of processing inputs at any of the resolutions on which it was trained. While some teacher models may be flexible, meaning that they are configured to process inputs of different resolutions, other teacher models may be non-flexible, meaning that they are configured to only process inputs of a single resolution. FIG. 2 illustrates various possible training scenarios, as described herein.
Scenario 1: The teacher model supports the resolution at which the student model is being trained. In this scenario, the student model is trained from the teacher model by causing the teacher model to process an input with the resolution to generate a first output with the resolution, causing the student model to process the input with the resolution to generate a second output with the resolution, computing a loss between the first output and the second output, and updating the student model based on the loss.
Scenario 2: The teacher model supports only a lower resolution than the resolution at which the student model is being trained. In this scenario, the student model is trained from the teacher model by preprocessing (e.g. downsampling) the output of the student model to align the resolution of the output to the resolution supported by the teacher model. For example, the training process may include: causing the teacher model to process an input at its supported (lower) resolution to generate a first output with the lower resolution, causing the student model to process the input with the (training) resolution at which the student model is being trained to generate a second output with the training resolution, downsampling the second output to form a downsampled second output with the lower resolution, computing a loss between the first output and the downsampled second output, and updating the student model based on the loss. As another option for this scenario, the student model is trained from the teacher model by preprocessing (e.g. upsampling) the output of the teacher model to align the resolution of the output to the resolution at which the student model is being trained. For example, the training process may include: causing the teacher model to process an input at its supported (lower) resolution to generate a first output with the lower resolution, upsampling the first output to form an upsampled second output with the (training) resolution at which the student model is being trained, causing the student model to process the input with the training) resolution to generate a third output with the training resolution, computing a loss between the upsampled second output and the third output, and updating the student model based on the loss.
Scenario 3: The teacher model supports only a higher resolution than the resolution at which the student model is being trained. In this scenario, the student model is trained from the teacher model by preprocessing the input of the teacher model. For example, the training process may include: aggregating a plurality of inputs having the (training) resolution at which the student model is being trained to form an aggregate input with the higher resolution supported by the teacher model, causing the teacher model to process the aggregate input with the higher resolution to generate a first output with the higher resolution, apportioning the first output into a plurality of second outputs that each correspond to a different one of the plurality of inputs and that each have the training resolution, causing the student model to process the plurality of inputs having the training resolution to generate a plurality of third outputs with the training resolution, and for each input of the plurality of inputs: computing a loss between the second output of the plurality of second outputs that corresponds to the input and the third output of the plurality of third outputs that corresponds to the input, and updating the student model based on the loss.

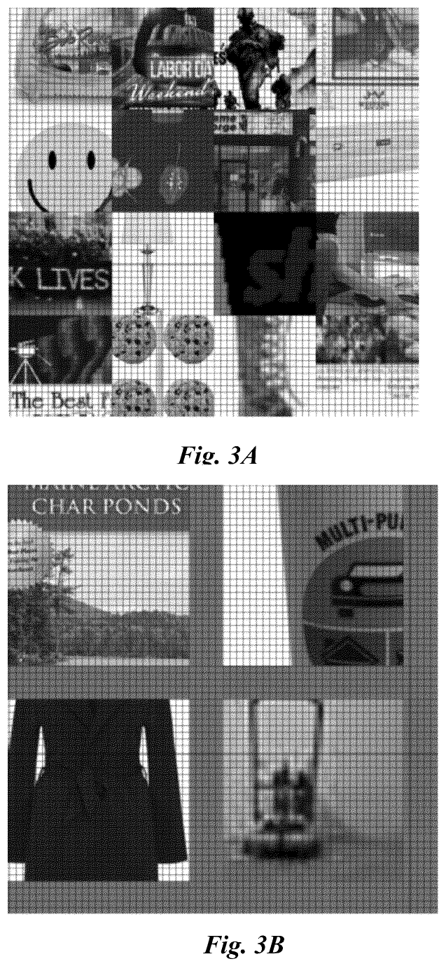

In an embodiment, the aggregate input at the higher resolution may be considered a “mosaic” of smaller (i.e. resolution-wise) images, with or without additional “padding”, or default blocks (e.g. pixels), situated between the smaller images and/or situated at one or more edges of the smaller images. In an embodiment, the teacher model processes the mosaic to generate an output at the higher resolution, which is then cropped per smaller image for training the student model. FIG. 3A illustrates an exemplary mosaic of images that may be used in the system framework of FIG. 2, in accordance with an embodiment. FIG. 3B illustrates an exemplary padded mosaic of images that may be used in the system framework of FIG. 2, in accordance with an embodiment.

### Exemplary Implementation

As described above, with multi-resolution training the student model is able to learn from all teacher models across multiple resolutions. In an exemplary implementation, the teacher models may include DINO (Distillation with No Labels) model, a CLIP (Contrastive Language-Image Pre-Training) model, and a SAM (Segment Anything Model).

Since DINOv2 can infer images at any resolution, the input to this teacher model may simply have a same resolution as the resolution at which the student model is being trained. For a CLIP (Contrastive Language-Image Pre-Training) teacher model, images at the teacher's native resolution may be input to the teacher model, and the student model may be fed with images at one or more different (i.e. higher) resolutions. Student features may be interpolated down to the resolution of the teacher's features before applying the loss function. For SAM, in the case that it supports a higher resolution than the resolution at which the student model is being trained, then an aggregate (with optional padding) of smaller images each having the training resolution may be input to SAM and its output then cropped to the effective size of the unpadded image.

In an exemplary embodiment, the student model may be trained for 600,000 iterations. In this embodiment, the training may be broken down into three stages. In a first stage, the student model is trained from every teacher model at low resolution (e.g. 256²) for 300 k iterations. In a second stage, the student model is trained from every teacher model at medium resolution (e.g. 432²) for 300 k iterations. In the third stage, the student model is trained simultaneously at the medium resolution and at a high resolution (e.g. 1,024²) for 300 k iterations. In an embodiment, for the student model to be consistently accurate across resolutions, it may be sufficient to match all teachers at all resolutions, and then to also train at two resolutions simultaneously in a final training stage.

The training schedule described above involves running SAM inference on aggregate images, and using cropped features to train the student against SAM at low resolution. In an embodiment, efficiency may be improved when training a student model at a resolution ≤512² against SAM, by instead creating a mosaic of k×k images, with

$$k = \frac{1 , {024}^{2}}{x}$$

with x being the student resolution, resulting in a single 1,024² image. Then SAM inference may be performed on this mosaic and k² individual feature maps may be extracted to train the student model.

Mosaic augmentation may include padding aggregate lower resolution images as needed to maximize efficiency. For example, to train a student model at 432² resolution, a 2×2 mosaic may be created with 80-pixel padding around each image. FIGS. 3A and 3B show sample mosaic augmentations under 256 and 432 student model resolutions. In an embodiment, cleaner output features may be obtained after applying mosaic augmentation, which may be due to the increased diversity in image positions, helping to reduce positional encoding artifacts. To this end, mosaic augmentation may greatly reduce the training cost associated with learning from high-resolution teachers and may eliminate the need for feature interpolation. Student model quality may even be improved with this optimization.

### Teacher Loss Balancing

When the different teacher models have different distribution moments, or a certain degree of variations in activation magnitudes, learning by the student model may be biased toward certain teacher models (e.g. such as those with greater magnitude of activations). In the exemplary implementation above, for example, SAM's activations tend to overshadow those of CLIP and DINOv2 models. To address this biased learning, the teacher models may be normalized prior to training of the student model, and the trained student model may be configured to reverse the normalization at inference time.

In an embodiment, the PCA-Hadamard Isotropic Standardization (PHI-S) method may be used for achieving improved balance among teacher model losses. PHI-S rotates teacher activations to evenly distribute variance across all channels and then scales them to obtain unit variance. This process can be easily reversed by projecting the student activations back into each teacher's original feature space. PHI-S may enhance training stability and overall benchmark performance.

For a given teacher feature map X with embedding size C, PHI-S applies the following transformation:

$${X}_{i}^{′} = {∅}_{i}^{- 1} {R}_{i} {X}_{i} , {R}_{i} = {H}_{C} {U}_{i}^{⊤} , {∅}_{i} = \sqrt{\frac{1}{C} {\sum }_{j}^{C} {λ}_{j}}$$

where H_{C} is a normalized Hadamard matrix of dimension C, λⱼ are the Eigen values of the covariance matrix Σ[X], and U are the corresponding eigenvectors. φᵢ and Rᵢ are specific to the ith teacher.

As a starting point, a measure of fidelity is defined without the use of labels or explicitly produced distributions over classes. Instead, since the loss objective is to directly match the features of the teachers, this results in the function:

$${F}_{i} [ X ] = \frac{Var [ {t}_{i} ( X ) ]}{Var [ f ( X ) - {t}_{i} ( X ) ]} = \frac{{∅}_{i}^{2}}{MSE ( f ( X ) , {t}_{i} ( X ) )}$$

with f(X) being the student feature distribution, and tᵢ(X) being the ith teacher distribution. This function represents the ratio of the target distribution variance to the student model's estimation error variance. A value of ≤1 means random sampling from the teacher distribution would be better, and ∞ would be perfect matching. To this end, the use of normalization, such as PHI-S, may help balance the energy spent learning from each teacher.

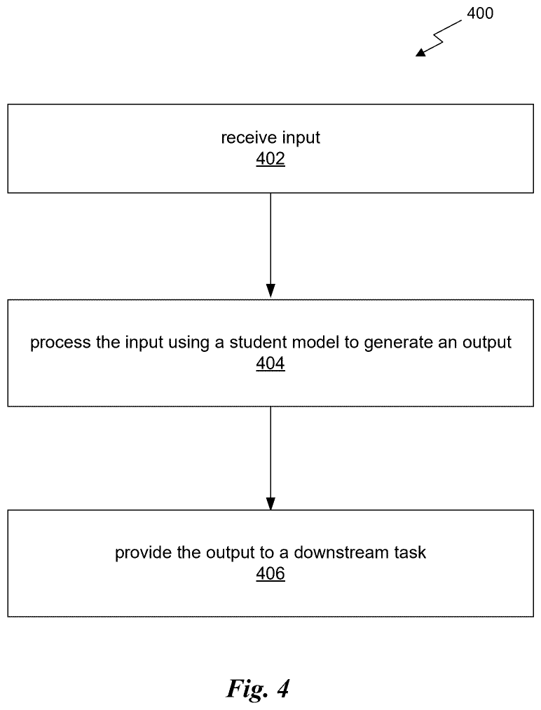

FIG. 4 illustrates a flowchart of a method 400 for executing a trained student model to generate an output, in accordance with an embodiment. The method 400 may be carried out in the context of the systems and methods described herein. For example, the student model may be trained per the method 100 of FIG. 1A and/or the method 150 of FIG. 1B, and the method 400 may be performed by the student model at inference time. Thus, any of the descriptions of the embodiments described herein may apply to the present method 400.

In operation 402, an input is received. In an embodiment, the input may be an image or a video (e.g. video frame). In an embodiment, the input may have a resolution on which the student model has been trained. In an embodiment, the input may be received from an application, such as the downstream application described in more detail below.

In operation 404, the input is processed using the student model to generate an output. In an embodiment, the output may be a feature representation (e.g. feature map) generated for the input. In an embodiment where the student model has been trained on normalized teacher models, the student model may reverse the normalization when generating the output.

In operation 406, the output is provided to a downstream task. In an embodiment, the downstream task may be a process executed by the downstream application mentioned above. For example, the downstream application may be a LLM or a vector database. In this way, the downstream task may be executed to process the output from the student model to generate another output.

By way of example, for each input image, the student model may output a summary vector along with (e.g. patch) tokens (e.g. at a granularity of one per 162 input pixel block). The summary vector may provide a rich embedding for downstream image-level tasks such as classification, search, or curation. The patch tokens may also be used for dense downstream tasks such as segmentation or 3D understanding.

In an embodiment, the student model may compress its output prior to providing the same to the downstream task. For example, where the output includes feature tokens for a given input (e.g. image or video), the student model may compress the feature tokens. This compression may include, in an embodiment, merging subsets of the feature tokens at least in part by degree of similarity.

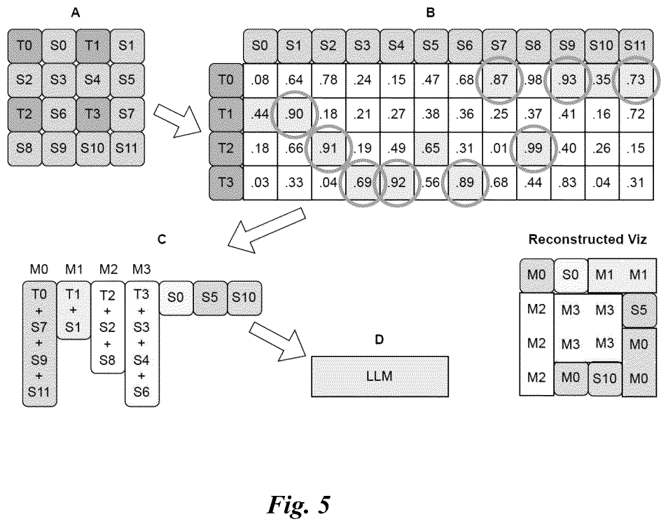

FIG. 5 illustrates an example method of using bipartite matching for token compression. In an embodiment, bipartite soft matching is used to merge similar tokens. Strided partitioning is applied to ensure that each image region retains some representation in the compressed features. For evaluation, merged token indices are tracked, enabling the tokens to be unmerged and the reconstruction error to be measured for informing hyperparameter selection.

In the example illustrated in FIG. 5, the bipartite matching is performed using a 2×2 strided pattern with r=9. In (A), the original tokens (T0, T1, T2, T3) are assigned as targets, and the remaining tokens are assigned as sources. In (B), the affinity between each source and target is computed. In an embodiment, only the maximum affinity for each source (shown as highlighted) is considered. The r highest affinity squares are determined, and those are merged into their respective targets. In (C), the output tokens are illustrated with merged values when a given ‘T #’ was assigned one or more sources. In (D), the final 7 tokens are fed to the LLM. Reconstructed Viz: From (C), the compressed original feature map can be visualized by broadcasting the merged tokens to all of the source locations.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

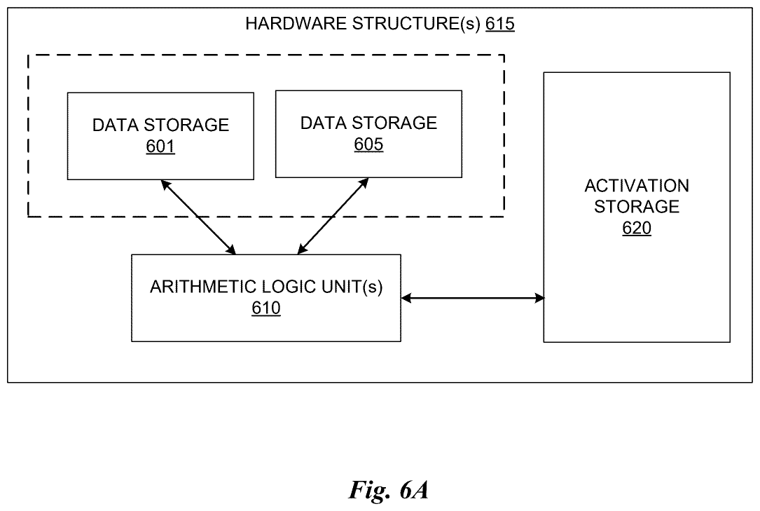

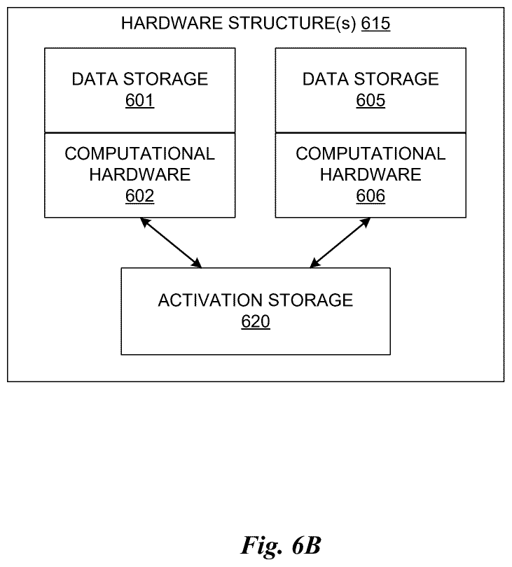

As noted above, a deep learning or neural learning system needs to be trained to generate inferences from input data. Details regarding inference and/or training logic 615 for a deep learning or neural learning system are provided below in conjunction with FIGS. 6A and/or 6B.

In at least one embodiment, inference and/or training logic 615 may include, without limitation, a data storage 601 to store forward and/or output weight and/or input/output data corresponding to neurons or layers of a neural network trained and/or used for inferencing in aspects of one or more embodiments. In at least one embodiment data storage 601 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 601 may be included with other on-chip or off-chip data storage, including a processor's L1, L2, or L3 cache or system memory.

In at least one embodiment, any portion of data storage 601 may be internal or external to one or more processors or other hardware logic devices or circuits. In at least one embodiment, data storage 601 may be cache memory, dynamic randomly addressable memory (“DRAM”), static randomly addressable memory (“SRAM”), non-volatile memory (e.g., Flash memory), or other storage. In at least one embodiment, choice of whether data storage 601 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 615 may include, without limitation, a data storage 605 to store backward and/or output weight and/or input/output data corresponding to neurons or layers of a neural network trained and/or used for inferencing in aspects of one or more embodiments. In at least one embodiment, data storage 605 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 605 may be included with other on-chip or off-chip data storage, including a processor's L1, L2, or L3 cache or system memory. In at least one embodiment, any portion of data storage 605 may be internal or external to on one or more processors or other hardware logic devices or circuits. In at least one embodiment, data storage 605 may be cache memory, DRAM, SRAM, non-volatile memory (e.g., Flash memory), or other storage. In at least one embodiment, choice of whether data storage 605 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 601 and data storage 605 may be separate storage structures. In at least one embodiment, data storage 601 and data storage 605 may be same storage structure. In at least one embodiment, data storage 601 and data storage 605 may be partially same storage structure and partially separate storage structures. In at least one embodiment, any portion of data storage 601 and data storage 605 may be included with other on-chip or off-chip data storage, including a processor's L1, L2, or L3 cache or system memory.

In at least one embodiment, inference and/or training logic 615 may include, without limitation, one or more arithmetic logic unit(s) (“ALU(s)”) 610 to perform logical and/or mathematical operations based, at least in part on, or indicated by, training and/or inference code, result of which may result in activations (e.g., output values from layers or neurons within a neural network) stored in an activation storage 620 that are functions of input/output and/or weight parameter data stored in data storage 601 and/or data storage 605. In at least one embodiment, activations stored in activation storage 620 are generated according to linear algebraic and or matrix-based mathematics performed by ALU(s) 610 in response to performing instructions or other code, wherein weight values stored in data storage 605 and/or data 601 arc used as operands along with other values, such as bias values, gradient information, momentum values, or other parameters or hyperparameters, any or all of which may be stored in data storage 605 or data storage 601 or another storage on or off-chip. In at least one embodiment, ALU(s) 610 are included within one or more processors or other hardware logic devices or circuits, whereas in another embodiment, ALU(s) 610 may be external to a processor or other hardware logic device or circuit that uses them (e.g., a co-processor). In at least one embodiment, ALUs 610 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 601, data storage 605, and activation storage 620 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 620 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 620 may be cache memory, DRAM, SRAM, non-volatile memory (e.g., Flash memory), or other storage. In at least one embodiment, activation storage 620 may be completely or partially within or external to one or more processors or other logical circuits. In at least one embodiment, choice of whether activation storage 620 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 615 illustrated in FIG. 6A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6A may be used in conjunction with central processing unit (“CPU”) hardware, graphics processing unit (“GPU”) hardware or other hardware, such as field programmable gate arrays (“FPGAs”).

FIG. 6B illustrates inference and/or training logic 615, according to at least one embodiment. In at least one embodiment, inference and/or training logic 615 may include, without limitation, hardware logic in which computational resources are dedicated or otherwise exclusively used in conjunction with weight values or other information corresponding to one or more layers of neurons within a neural network. In at least one embodiment, inference and/or training logic 615 illustrated in FIG. 6B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 615 illustrated in FIG. 6B may be used in conjunction with central processing unit (CPU) hardware, graphics processing unit (GPU) hardware or other hardware, such as field programmable gate arrays (FPGAs). In at least one embodiment, inference and/or training logic 615 includes, without limitation, data storage 601 and data storage 605, which may be used to store weight values and/or other information, including bias values, gradient information, momentum values, and/or other parameter or hyperparameter information. In at least one embodiment illustrated in FIG. 6B, each of data storage 601 and data storage 605 is associated with a dedicated computational resource, such as computational hardware 602 and computational hardware 606, respectively. In at least one embodiment, each of computational hardware 606 comprises one or more ALUs that perform mathematical functions, such as linear algebraic functions, only on information stored in data storage 601 and data storage 605, respectively, result of which is stored in activation storage 620.

In at least one embodiment, each of data storage 601 and 605 and corresponding computational hardware 602 and 606, respectively, correspond to different layers of a neural network, such that resulting activation from one “storage/computational pair 601/602” of data storage 601 and computational hardware 602 is provided as an input to next “storage/computational pair 605/606” of data storage 605 and computational hardware 606, in order to mirror conceptual organization of a neural network. In at least one embodiment, each of storage/computational pairs 601/602 and 605/606 may correspond to more than one neural network layer. In at least one embodiment, additional storage/computation pairs (not shown) subsequent to or in parallel with storage computation pairs 601/602 and 605/606 may be included in inference and/or training logic 615.

### Neural Network Training and Deployment

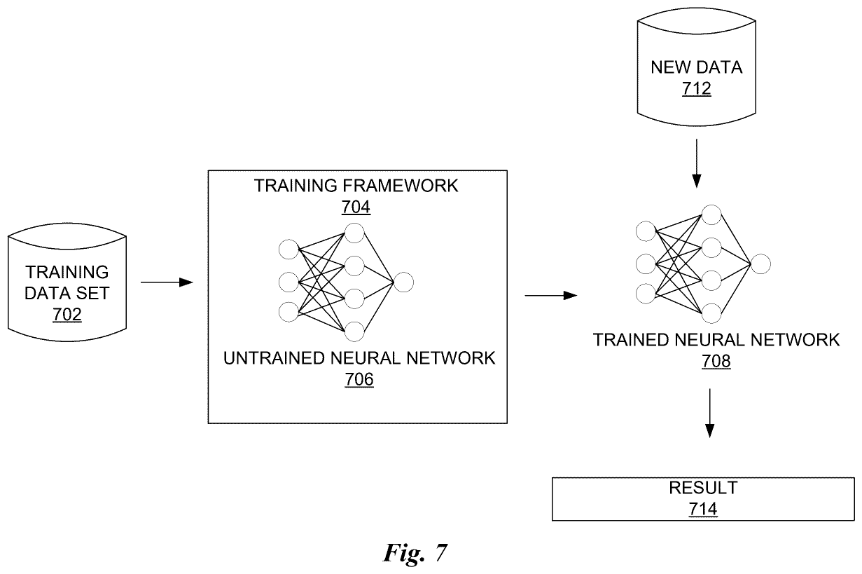

FIG. 7 illustrates another embodiment for training and deployment of a deep neural network. In at least one embodiment, untrained neural network 706 is trained using a training dataset 702. In at least one embodiment, training framework 704 is a PyTorch framework, whereas in other embodiments, training framework 704 is a Tensorflow, Boost, Caffe, Microsoft Cognitive Toolkit/CNTK, MXNet, Chainer, Keras, Deeplearning4j, or other training framework. In at least one embodiment training framework 704 trains an untrained neural network 706 and enables it to be trained using processing resources described herein to generate a trained neural network 708. In at least one embodiment, weights may be chosen randomly or by pre-training using a deep belief network. In at least one embodiment, training may be performed in either a supervised, partially supervised, or unsupervised manner.

In at least one embodiment, untrained neural network 706 is trained using supervised learning, wherein training dataset 702 includes an input paired with a desired output for an input, or where training dataset 702 includes input having known output and the output of the neural network is manually graded. In at least one embodiment, untrained neural network 706 is trained in a supervised manner processes inputs from training dataset 702 and compares resulting outputs against a set of expected or desired outputs. In at least one embodiment, errors are then propagated back through untrained neural network 706. In at least one embodiment, training framework 704 adjusts weights that control untrained neural network 706. In at least one embodiment, training framework 704 includes tools to monitor how well untrained neural network 706 is converging towards a model, such as trained neural network 708, suitable to generating correct answers, such as in result 714, based on known input data, such as new data 712. In at least one embodiment, training framework 704 trains untrained neural network 706 repeatedly while adjust weights to refine an output of untrained neural network 706 using a loss function and adjustment algorithm, such as stochastic gradient descent. In at least one embodiment, training framework 704 trains untrained neural network 706 until untrained neural network 706 achieves a desired accuracy. In at least one embodiment, trained neural network 708 can then be deployed to implement any number of machine learning operations.

In at least one embodiment, untrained neural network 706 is trained using unsupervised learning, wherein untrained neural network 706 attempts to train itself using unlabeled data. In at least one embodiment, unsupervised learning training dataset 702 will include input data without any associated output data or “ground truth” data. In at least one embodiment, untrained neural network 706 can learn groupings within training dataset 702 and can determine how individual inputs are related to untrained dataset 702. In at least one embodiment, unsupervised training can be used to generate a self-organizing map, which is a type of trained neural network 708 capable of performing operations useful in reducing dimensionality of new data 712. In at least one embodiment, unsupervised training can also be used to perform anomaly detection, which allows identification of data points in a new dataset 712 that deviate from normal patterns of new dataset 712.

In at least one embodiment, semi-supervised learning may be used, which is a technique in which in training dataset 702 includes a mix of labeled and unlabeled data. In at least one embodiment, training framework 704 may be used to perform incremental learning, such as through transferred learning techniques. In at least one embodiment, incremental learning enables trained neural network 708 to adapt to new data 712 without forgetting knowledge instilled within network during initial training.

### Data Center

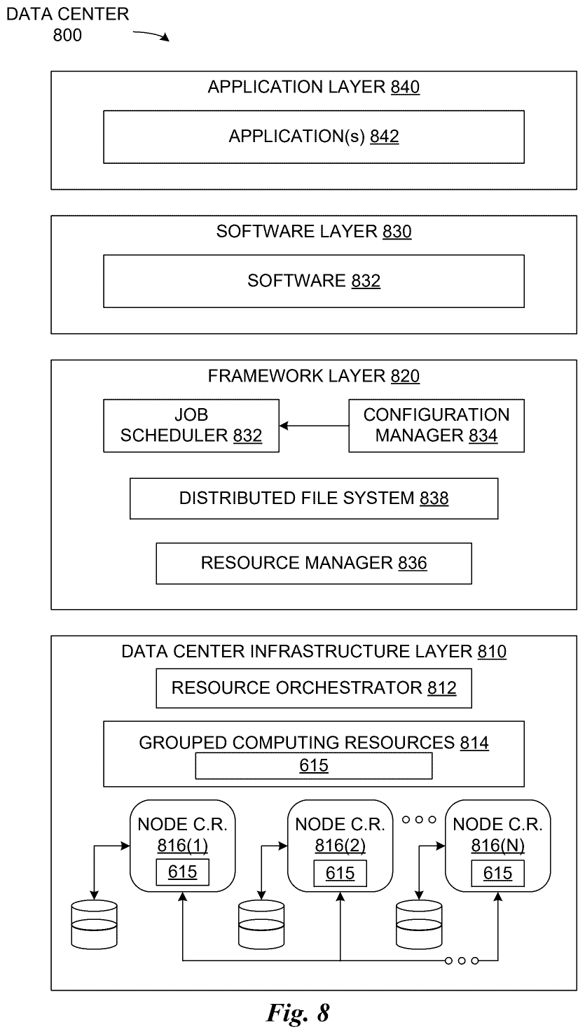

FIG. 8 illustrates an example data center 800, in which at least one embodiment may be used. In at least one embodiment, data center 800 includes a data center infrastructure layer 810, a framework layer 820, a software layer 830 and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 822 may configure or otherwise control one or more node C.R.s 816(1)-816(N) and/or grouped computing resources 814. In at least one embodiment, resource orchestrator 822 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 832, a configuration manager 834, a resource manager 836 and a distributed file system 838. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 832 may include a Spark driver to facilitate scheduling of workloads supported by various layers of data center 800. In at least one embodiment, configuration manager 834 may be capable of configuring different layers such as software layer 830 and framework layer 820 including Spark and distributed file system 838 for supporting large-scale data processing. In at least one embodiment, resource manager 836 may be capable of managing clustered or grouped computing resources mapped to or allocated for support of distributed file system 838 and job scheduler 832. In at least one embodiment, clustered or grouped computing resources may include grouped computing resource 814 at data center infrastructure layer 810. In at least one embodiment, resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 838 of framework layer 820. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underutilized and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 615 are used to perform inferencing and/or training operations associated with one or more embodiments. In at least one embodiment, inference and/or training logic 615 may be used in the system of FIG. 8 for inferencing or predicting operations based, at least in part, on weight parameters calculated using neural network training operations, neural network functions and/or architectures, or neural network use cases described herein.

As described herein, a method, computer readable medium, and system are disclosed to train a student model. In accordance with FIGS. 1-5, embodiments may provide one or more models usable for training the student model. The model(s) may be stored (partially or wholly) in one or both of data storage 601 and 605 in inference and/or training logic 615 as depicted in FIGS. 6A and 6B. Training and deployment of the model(s) may be performed as depicted in FIG. 7 and described herein. Distribution of the model(s) may be performed using one or more servers in a data center 800 as depicted in FIG. 8 and described herein.

What is claimed is:

1. A method, comprising:
at a device, training a student computer vision model from a plurality of teacher computer vision models by:
selecting a plurality of resolutions over which the student computer vision model is to be trained; and
for each resolution of the plurality of resolutions, training the student computer vision model from every teacher computer vision model of the plurality of teacher computer vision models.

2. The method of claim 1, wherein the plurality of teacher computer vision models are pretrained models.

3. The method of claim 1, wherein the plurality of teacher computer vision models are pretrained for at least one computer vision task.

4. The method of claim 3, wherein the plurality of teacher computer vision models are pretrained for a plurality of different computer vision tasks.

5. The method of claim 3, wherein the at least one computer vision task includes at least one of:
object detection,
instance segmentation, or
semantic segmentation.

6. The method of claim 1, wherein at least one flexible teacher computer vision model of the plurality of teacher computer vision models is configured to process inputs with a plurality of different resolutions.

7. The method of claim 6, wherein for each resolution of the plurality of resolutions, the student computer vision model is trained from each flexible teacher computer vision model of the at least one flexible teacher computer vision model by:
causing the flexible teacher computer vision model to process an input with the resolution to generate a first output with the resolution,
causing the student computer vision model to process the input with the resolution to generate a second output with the resolution,
computing a loss between the first output and the second output, and
updating the student computer vision model based on the loss.

8. The method of claim 1, wherein at least one non-flexible teacher computer vision model of the plurality of teacher computer vision models is configured to process inputs with only a single predefined resolution.

9. The method of claim 8, wherein for each resolution of the plurality of resolutions, the student computer vision model is trained from each non-flexible teacher computer vision model of the at least one non-flexible teacher computer vision model by:
determining whether the single predefined resolution at which the non-flexible teacher computer vision model is configured to process inputs matches the resolution at which the student computer vision model is being trained, and
performing a training process that is dependent on a result of the determination.

10. The method of claim 9, wherein when the single predefined resolution at which the non-flexible teacher computer vision model is configured to process inputs matches the resolution at which the student computer vision model is being trained, then the training process includes:
causing the non-flexible teacher computer vision model to process an input with the resolution to generate a first output with the resolution,
causing the student computer vision model to process the input with the resolution to generate a second output with the resolution,
computing a loss between the first output and the second output, and
updating the student computer vision model based on the loss.

11. The method of claim 9, wherein when the single predefined resolution at which the non-flexible teacher computer vision model is configured to process inputs is lower than the resolution at which the student computer vision model is being trained, then the training process includes:
causing the non-flexible teacher computer vision model to process an input with the single predefined resolution at which the non-flexible teacher computer vision model is configured to process inputs to generate a first output with the single predefined resolution,
causing the student computer vision model to process the input with the resolution at which the student computer vision model is being trained to generate a second output with the resolution at which the student computer vision model is being trained,
downsampling the second output to form a downsampled second output with a resolution that matches the single predefined resolution of the first output,
computing a loss between the first output and the downsampled second output, and
updating the student computer vision model based on the loss.

12. The method of claim 9, wherein when the single predefined resolution at which the non-flexible teacher computer vision model is configured to process inputs is higher than the resolution at which the student computer vision model is being trained, then the training process includes:
aggregating a plurality of inputs having the resolution at which the student computer vision model is being trained to form an aggregate input with the single predefined resolution at which the non-flexible teacher computer vision model is configured to process inputs,
causing the non-flexible teacher computer vision model to process the aggregate input with the single predefined resolution at which the non-flexible teacher computer vision model is configured to process inputs to generate a first output with the single predefined resolution,
apportioning the first output into a plurality of second outputs that each correspond to a different one of the plurality of inputs and that each have the resolution at which the student computer vision model is being trained,
causing the student computer vision model to process the plurality of inputs having the resolution at which the student computer vision model is being trained to generate a plurality of third outputs with the resolution at which the student computer vision model is being trained,
for each input of the plurality of inputs:
computing a loss between the second output of the plurality of second outputs that corresponds to the input and the third output of the plurality of third outputs that corresponds to the input, and
updating the student computer vision model based on the loss.

13. The method of claim 12, wherein the plurality of inputs are aggregated with a plurality of additional default blocks to form the aggregate input with the single predefined resolution at which the non-flexible teacher computer vision model is configured to process inputs.

14. The method of claim 1, wherein the student computer vision model is trained over the plurality of resolutions sequentially.

15. The method of claim 1, wherein the plurality of teacher computer vision models are normalized for use in training the student computer vision model.

16. The method of claim 15, wherein the student computer vision model is configured to reverse the normalization at inference time.

17. The method of claim 15, wherein the plurality of teacher computer vision models are normalized by rotating teacher activations to distribute variance across channels and then are scaled to obtain unit variance.

18. The method of claim 17, wherein the normalization is reversed by projecting student activations back into an original feature space of each of the plurality of teacher computer vision models.

19. The method of claim 1, wherein at inference time the student computer vision model is configured to generate feature tokens for a given input.

20. The method of claim 19, wherein at inference time the student computer vision model is further configured to compress the feature tokens.

21. The method of claim 20, wherein the student computer vision model is configured to compress the feature tokens by merging subsets of the feature tokens at least in part by degree of similarity.

22. The method of claim 1, further comprising, at the device:
causing the student computer vision model to be deployed for performing inferencing for one or more computer vision tasks.

23. The method of claim 22, wherein the student computer vision model is deployed for use by a downstream application.

24. The method of claim 22, wherein the student computer vision model is deployed for use by a downstream large language model (LLM).

25. The method of claim 22, wherein the student computer vision model is deployed for use by a downstream vector database.

26. A system, comprising:
a non-transitory memory storage comprising instructions; and
one or more processors in communication with the memory, wherein the one or more processors execute the instructions to train a student computer vision model from a plurality of teacher computer vision models by:
selecting a plurality of resolutions over which the student computer vision model is to be trained; and
for each resolution of the plurality of resolutions, training the student computer vision model from every teacher computer vision model of the plurality of teacher computer vision models.

27. The system of claim 26, wherein the one or more processors further execute the instructions to:
cause the student computer vision model to be deployed for performing inferencing for one or more computer vision tasks.

28. The system of claim 27, wherein the student computer vision model is deployed for use by at least one of:
a downstream large language model (LLM), or
a downstream vector database.

29. A non-transitory computer-readable media storing computer instructions which when executed by one or more processors of a device cause the device to train a student computer vision model from a plurality of teacher computer vision models by:
selecting a plurality of resolutions over which the student computer vision model is to be trained; and
for each resolution of the plurality of resolutions, training the student computer vision model from every teacher computer vision model of the plurality of teacher computer vision models.

30. A method, comprising:
at a device:
normalizing a plurality of teacher models to form a plurality of normalized teacher models;
training a student model from the plurality of normalized teacher models; and
configuring the trained student model to reverse the normalization at inference time.

31. The method of claim 30, wherein the plurality of teacher models are pretrained computer vision models, and wherein the student model is a computer vision model.

32. The method of claim 31, wherein the plurality of teacher models are pretrained for at least one computer vision task.

33. The method of claim 32, wherein the plurality of teacher models are pretrained for a plurality of different computer vision tasks.

34. The method of claim 32, wherein the at least one computer vision task includes at least one of:
object detection,
instance segmentation, or
semantic segmentation.

35. The method of claim 30, wherein normalizing the plurality of teacher models includes normalizing distributions of the plurality of teacher models.

36. The method of claim 35, wherein normalizing the distributions of the plurality of teacher models includes aligning the distributions across the plurality of teacher models.

37. The method of claim 35, wherein the student model learns to match the normalized distributions of the plurality of teacher models.

38. The method of claim 37, wherein the trained student model reverses the normalization at inference time by estimating the distributions of the teacher models using an inverse normalization process on predictions of the trained student model.

39. The method of claim 30, wherein the plurality of teacher models are normalized using an invertible linear mapping.

40. The method of claim 30, wherein the plurality of teacher models are normalized by rotating teacher activations to distribute variance across channels and then scaling to obtain unit variance.

41. The method of claim 40, wherein the normalization is reversed by projecting student activations back into an original feature space of each of the plurality of teacher models.

42. The method of claim 30, wherein the trained student model reverses the normalization by applying an inverse operation on predictions made by the trained student model.

43. The method of claim 30, further comprising, at the device:
causing the trained student model to be deployed.
